(19) United States
(12) Patent Application Publication
(10) Pub. No.: US 2024/0149557 A1
(43) Pub. Date: May 9, 2024

(54) Ceramic Surface Modification Materials

(71) Applicant: Nelumbo Inc., Hayward, CA (US)

(72) Inventors: Josh Rafshoon, Hayward, CA (US); Lance R. Brockway, Hayward, CA (US); David C. Walther, Hayward, CA (US)

(21) Appl. No.: 18/505,950

(22) Filed: Nov. 9, 2023

Related U.S. Application Data
(63) Continuation of application No. 17/784,486, filed on Jun. 10, 2022.
Application No. 17/784,486 is a continuation-in-part of application No. PCT/US2019/065978, filed on Dec. 12, 2019.
(60) Provisional application No. 62/989,092, filed on Mar. 13, 2020.
(60) Provisional application No. 62/989,150, filed on Mar. 13, 2020.
(60) Provisional application No. 63/038,642, filed on Jun. 12, 2020.
(60) Provisional application No. 63/038,693, filed on Jun. 12, 2020.
(60) Provisional application No. 63/039,965, filed on Jun. 16, 2020.

(51) Int. Cl. B32B 7/027; B32B 5/02; B32B 9/02; B32B 17/02; B32B 33/00; C04B 35/04; C04B 35/10; C04B 35/453; C04B 38/00; C08J 5/12; C09D 1/00; C09D 5/08; C09D 201/00; C23C 8/02; C23C 8/52; C23C 22/06; D06M 11/44; D06M 11/83; D06M 23/06; F28F 19/06

(52) U.S. Cl. CPC B32B 7/027; B32B 5/024; B32B 9/02; B32B 17/02; B32B 33/00; C04B 35/04; C04B 35/10; C04B 35/453; C04B 38/0058; C04B 38/0064; C04B 38/0096; C08J 5/121; C09D 1/00; C09D 5/08; C09D 201/00; C23C 8/02; C23C 8/52; C23C 22/06; D06M 11/44; D06M 11/83; D06M 23/06; F28F 19/06; B32B 2255/20; B32B 2262/08; B32B 2262/101; B32B 2262/128; B32B 2305/188; B32B 2307/304; B32B 2307/728; B32B 2307/73; B32B 2315/02; B32B 2315/08; B32B 2317/10; D06M 2101/06

(57) ABSTRACT

Porous, binderless ceramic surface modification materials are described, and applications of use thereof. The ceramic surface material is in the form of an interconnected network of porous ceramic material on a substrate. The ceramic material may include a metal oxide, a metal hydroxide, and/or hydrates thereof, or a metal carbonate or metal phosphate, on a substrate surface. The substrate may be in the form of a metal or polymer particulate, powder, extrudate, or flakes.

### CROSS-REFERENCE TO RELATED APPLICATIONS

This application claims priority to PCT Application No. PCT/US2019/065978, filed on Dec. 12, 2019, and claims the benefit of U.S. Provisional Application No. 62/989,092, filed on Mar. 13, 2020, 62/989,150, filed on Mar. 13, 2020, 63/038,642, filed on Jun. 12, 2020, 63/038,693, filed on Jun. 12, 2020, and 63/039,965, filed on Jun. 16, 2020, all of which are incorporated herein by reference in their entireties.

### FIELD OF THE INVENTION

This invention relates to a porous ceramic material that includes an interconnected network of ceramic, such as a metal oxide, metal hydroxide, metal carbonate, metal titanate, or metal phosphate ceramic, immobilized on a substrate surface.

### BACKGROUND

Conversion coatings are a common method to add a functional layer on many metals and metal alloys, providing a functional property such as adhesion or corrosion inhibition. These coatings act to convert a natural oxide and/or hydroxide layer on the surface of the metal to another material. Common conversion coatings include chromate and phosphate conversions, bluing, and anodizing. These processes all add a protective coating to the underlying metal. Other types of coatings can be deposited onto surfaces such as paints, drying oils, or other polymers. These coatings typically require primers or have adhesion issues, use temperature limitations, and lack UV resistance. New materials that provide advantages of both of these existing technologies are desirable.

### BRIEF SUMMARY OF THE INVENTION

Ceramic surface modified substrates and applications of use thereof are provided herein.

In one aspect, a composition is provided that includes a porous ceramic material that includes an interconnected network ceramic material that is in contact with a substrate. In some embodiments, at least about 20%, 30%, 40%, 50%, 55%, 60%, 65%, 70%, 75%, 80%, 85%, 90%, or 95% of the ceramic material by mass is interconnected. In some embodiments, the porous ceramic material is binderless. In some embodiments, at least a portion, a majority, or substantially all of the interconnected network of ceramic material is in direct contact with the substrate. In other embodiments, the interconnected network of ceramic network material may be in indirect contact with the substrate, for example, in contact with a surface modification or treatment on the substrate surface

In some embodiments, the substrate and the ceramic material each include a primary metal, and the primary metal in the ceramic material is different than the primary metal in the substrate.

In some embodiments, the ceramic material on the substrate has a thickness of about 1 micrometer to about 100 micrometers.

In various embodiments, the ceramic material includes a rare earth element, a transition metal element, an alkaline earth metal element, or aluminum. In certain embodiments, the ceramic material includes an oxide, a hydroxide, or a layered double hydroxide. For example, the oxide, hydroxide, or layered double hydroxide may include one or more of: iron, aluminum, magnesium, cerium, zinc, manganese, titanium, chromium, vanadium, zirconium, nickel, cobalt, copper, silver, tantalum, tungsten, silicon, phosphorus, calcium, barium, tin, and europium. In certain embodiments, the ceramic material comprises a phosphate, a carbonate, a titanate, an aluminate, a zirconate, a fluoroaluminate, a silicate, a sulfide, a vanadate, a tungstate, a stannate, or a sulfate.

The substrate may include an aluminum alloy, a magnesium alloy, a steel alloy, a nickel alloy, a titanium alloy, a polymer, a cellulosic material (such as, but not limited to, wood, rayon, or cotton), a polysaccharide, such as a starch (e.g., thermoplastic starch, amylose, or amylopectin), hemicellulose, carrageenan, a polysaccharide, or glass. For example, the substrate may be in the form of a particle, powder, extrudate, flake, or lobed structure. In some embodiments, the substrate comprises a largest dimension that is less than any of about 5 mm, 4, mm, 3 mm, 2 mm, 1 mm, 500 microns, 250 microns, or 100 microns.

In some embodiments, the porous ceramic material is primarily crystalline. In some embodiments, the porous ceramic material comprises a surface area of about 10 m² to 1500 m² per square meter of projected substrate area. In some embodiment, the porous ceramic material includes a surface area of about 15 m² to 1500 m² per gram of ceramic material. In some embodiments, the porous ceramic material includes a mean pore diameter of about 2 nm to about 20 nm. In some embodiments, the pore size distribution. In some embodiments, the porous ceramic material includes a thickness up to about 50 micrometers, such as, for example, a thickness of about 0.2 micrometers to about 25 micrometers. In some embodiments, the porous ceramic material includes a porosity greater than about 10%, such as, for example, a porosity of about 30% to about 95%. In some embodiments, the porous ceramic material includes a void volume of about 100 mm³/g to about 7500 mm³/g as determined by mercury intrusion porosimetry.

In some embodiments, the porous ceramic material includes pores that are partially or completely filled with a gas, liquid, or solid substance, or combinations thereof. For example, the porous ceramic material may include pores that are partially or completely filled with a second ceramic material, which may be the same or different composition than the composition of the interconnected ceramic network that is in contact with the substrate. In certain embodiments, the interconnected ceramic network and the second ceramic material include different compositions, wherein the interconnected ceramic network includes a hydroxide, an oxide, or a layered double hydroxide and the second ceramic material includes a phosphate, a carbonate, a silicate, a sulfate, a titanate, a tungstate, a zirconate, a vanadate, a stannate, a zincate, or an aluminate. In some embodiments, the interconnected ceramic network and the second ceramic material each include a primary metal, and the primary metal of the interconnected ceramic network and the primary metal of the second ceramic material are the same or different. In some embodiments, an interface between the interconnected ceramic network and second ceramic material includes a gradient, such as a wherein the interface comprises a gradient (e.g., a composition gradient) of phosphorus, carbon, silicon, sulfur, tungsten, titanium, vanadium, manganese, magnesium, zinc, tin, zirconium, or aluminum. In one embodiment, the interconnected ceramic network includes a metal oxide and/or hydroxide (e.g., magnesium oxide and/or hydroxide) and the second ceramic material is a different composition (e.g., magnesium carbonate or magnesium phosphate), and there is a gradient at the interface between the two compositions, e.g., a carbon or phosphorous gradient at the interface.

In another aspect, a metal-ceramic or polymer-ceramic composite is provided. The metal-ceramic or polymer-ceramic composite may include an “assembly” of ceramic modified substrates as described herein, i.e., substrates modified with an interconnected network of porous ceramic material, optionally a binderless interconnected network of porous ceramic material, in contact with the substrate. For example, a plurality of the modified substrates may be processed (e.g., via sintering, casting, or molding) into a metal-ceramic or polymer-ceramic composite material. In certain embodiments, the plurality of ceramic modified substrates include particles, powders, flakes, or extrudates, for example, each including a largest dimension of less than any of about 5 mm, 4, mm, 3 mm, 2 mm, 1 mm, 500 microns, 250 microns, or 100 microns.

In another aspect, a method of manufacturing is provided. The method includes depositing a binderless interconnected network of porous ceramic material on a metal or polymer substrate that is in the form of a metal or polymer particulate, powder, extrudate, or flakes, thereby producing a surface modified metal or polymer substrate. The surface modified metal or polymer substrate is molded, cast, or sintered into a monolithic or net shape ceramic or metal-ceramic or polymer-ceramic composite component. The metal or polymer substrate core includes a lower melting point than the interconnected network of porous ceramic material and the ceramic is sufficiently porous to wick in and/or react with the molten metal or polymer of the core during processing (e.g., molding, casting, sintering). In some embodiments, the metal particulate, powder, extrudate, or flakes include aluminum, an aluminum alloy, magnesium, a magnesium alloy, zinc, a zinc alloy, calcium, or a calcium alloy. In some embodiments, the polymer particulate, powder, extrudate or flakes include polyolefin, polyester, polystyrene, polyamide, thermoplastic, starch, acrylic, or polycarbonate. In some embodiments, the ceramic includes magnesium oxide, titanium oxide, zinc oxide, manganese oxide, zirconium oxide, silica, or calcium carbonate.

### BRIEF DESCRIPTION OF THE DRAWINGS

FIGS. 1A-1B show a ceramic surface before (1A) and after (1B) the partial filling of the pores with an alkyl phosphonic acid monolayer. The larger pores are maintained and slightly shifted to a smaller pore size due to the partial filling of the pores while any pore size less than about 2.7 nm was filled and no longer measured as determined by BJH adsorption/desorption. Note: the observed effect at around 50 angstroms corresponds to an experimental artifact during which liquid nitrogen probe condensed in the pores under non-equilibrium conditions rapidly evaporates.

### DETAILED DESCRIPTION

The invention provides deposited synthetic, interconnected networks of ceramic (for example—metal oxide, hydroxide, carbonate, or phosphate) on a substrate, which provide desirable functional properties, such as improved corrosion performance and/or modified electrical conductivity. In some embodiments, the ceramic is binderless (e.g., surface immobilized). A first ceramic that is deposited on a substrate may include an accessible pore volume that is partially or completely filled with a second ceramic (e.g., a metal oxide, hydroxide, carbonate, or phosphate ceramic), or the first ceramic may be partially or completely converted into a second ceramic (e.g., a metal oxide, hydroxide, carbonate, or phosphate ceramic), or any combination thereof. The resulting ceramic materials are useful in many applications, such as, but not limited to, metal surface coatings, such as on surfaces of heat exchangers or boats, to minimize corrosion or fouling, as electrical insulators, as high temperature barrier coatings, as UV resistant coatings, and/or to manipulate condensate or fluids.

The invention also provides methods of application of non-oxide ceramic coatings on a substrate. For example, a ceramic metal oxide (e.g., magnesium oxide) film or layer deposited onto a metal substrate (e.g., aluminum) may be converted into a metal compound (e.g., metal phosphate or metal carbonate) film or layer. The converted film or layer may retain structural artifacts of the base structure of the original ceramic metal oxide film or layer.

### Definitions

Numeric ranges provided herein are inclusive of the numbers defining the range.

“A,” “an” and “the” include plural references unless the context clearly dictates otherwise.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.”

“Binder” or binding agent is any material or substance that holds or draws other materials together to form a cohesive whole mechanically, chemically, by adhesion or cohesion.

“Binderless” refers to absence of a binder that may be exogenously added to a primary material to improve structural integrity, particularly with regard to an organic binder or resin (e.g., polymers, glues, adhesives, asphalt) or inorganic binder (e.g., lime, cement glass, gypsum, etc.).

“Capillary climb” refers to a surface tension driven flow of liquid up a sample (the capillary climb is parallel to, and opposite to, the direction of the force (vector) due to gravity) upon contact with a free surface of liquid as a result of the porous substrate.

A “cellulosic” material refers to a material that is constructed of or that contains cellulose or derivatives of cellulose, e.g., ethers or esters of cellulose.

A “ceramic” or “ceramic material” refers to a solid material including an inorganic compound of a metal or a metalloid, and a non-metal, with ionic or covalent bonds. A “non-metal” may include oxygen (oxide ceramic), or carbon (carbide) or nitrogen (nitride) (non-oxide ceramics). A “metal” may include a non-hydrogen element of Group 1 of the periodic table, an element of Groups 2-12 of the periodic table, or an element from the p-block (Groups 12-17 of the periodic table), e.g., Al, Ga, In, Tl, Sn, Pb, Bi, or combinations thereof. A “metalloid” may include B, Si, Ge, As, Sb, Se, Te, or Po, or combinations thereof.

“Contact angle” refers to the angle measured through a liquid between a surface and the liquid-vapor interface at the contacting surface.

“Contiguous” or “contiguity” refers to pores and structures that contain walls and features in direct contact with one another or that share a common wall across a region or dimension large relative to an individual pore or structure.

A “conversion coating” refers to a surface layer in which reactants are chemically reacted with the surface to be treated, which converts the substrate, or a coating thereon, such as a ceramic (e.g., metal oxide and/or hydroxide) coating into a different compound. This process is typically not additive or a deposition, but may result in a small mass change.

“First quartile pore diameter” refers to the value of the pore diameter at which the cumulative pore surface area determined in the direction of increasing pore size is equivalent to 25% of the total cumulative pore surface area as determined by BJH gas adsorption/desorption measurements.

A “functional material layer” refers to a layer of material which may serve as the uppermost surface layer interacting with the surrounding environment or may serve as an interfacial layer for subsequent materials (intermediate layer between two other layers of material). A functional material layer imparts one or more desirable functional properties to the underlying substrate and/or the material on which it is deposited.

A “gradient” refers herein to a quantitative increase or decrease in one or more physical or chemical property of a material observed by passing spatially from one point to another point along a substrate surface on which the material is situated or immobilized, and varying in an x, y, or z direction in Cartesian coordinates on or through the material. Nonlimiting examples of gradient properties include thickness, density, hardness, ductility, pore size, pore size distribution, pore filling fraction, or chemical or physical composition, including but not limited to, oxidation state, metal concentration, or crosslinking density, for example, resulting in variation in isoelectric point, electrical conductivity, thermal conductivity, capacitance, etc.

“Hydrophilic” refers to a surface that has a high affinity for water. Contact angles can be very low (e.g. less than 30 degrees as measured from the surface through the liquid water in the presence of air) and/or immeasurable.

“Continuous ceramic network” or “continuous network of ceramic material” or “interconnected network of ceramic” refers to a network or matrix of ceramic material, wherein ceramic material in the network is in physical contact with (connected to) other ceramic material in the network, i.e., a majority of ceramic material is adjoined to other ceramic material resulting in a scaffolded structure either free-standing or supported on a substrate. The interconnected ceramic network described herein is a continuous ceramic phase over a macroscopic area or volume, and may contain pores (open spaces) with an accessible pore volume, which may be filled, or partially filled, with another material, such as, but not limited to, another ceramic.

“Layered double hydroxide” refers a class of ionic solids characterized by a layered structure with the generic sequence [AcB Z AcB]ₙ, where c represents layers of metal cations, A and B are layers of hydroxide anions, and Z are layers of other anions and/or neutral molecules (such as water). Layered double hydroxides are also described in PCT Application No. PCT/US2017/052120, which is incorporated by reference herein in its entirety.

A “macro void” refers to a geometric space within solid that has a characteristic dimension substantially larger than the characteristic dimension of an individual pore or feature (e.g., thickness), for example, at least about 5× to about 10× or about 10× to about 100× greater than the characteristic dimension.

“Mean” refers to the arithmetic mean or average.

“Mean pore diameter” is calculated using total surface area and total volume measurements from the Barrett-Joyner-Halenda (BJH) adsorption/desorption method as 4 times the total pore volume divided by the total surface area (4V/A), assuming a cylindrical pore.

“Multimodal” refers to a distribution which contains more than one different mode that appears as more than one distinct peak.

“Permeability” in fluid mechanics is a measure of the ability of a porous material to allow fluids to pass through it. The permeability of a medium is related to the porosity, but also to the shapes of the pores in the medium and their level of connectedness.

“Pore size distribution” refers to the relative abundance of each pore diameter or range or pore diameters as determined by mercury intrusion porosimetry (MIP) and Washburn's equation.

“Porosity” is a measure of the void (i.e., “empty”) spaces in a material, and is a fraction of the volume of voids, i.e., macro voids. over the total volume, between 0 and 1, or as a percentage between 0% and 100%. Porosities disclosed herein were measured by mercury intrusion porosimetry.

“Porous” refers to spaces, holes, or voids within a solid material.

“Superhydrophobic” refers to a surface that is extremely difficult to wet. The contact angle of a water droplet on a superhydrophobic material here a superhydrophobic surface refers to a sessile drop contact angles >150°. Highly hydrophobic contact angles are >120. Contact angles noted here are angles formed between the surface through the liquid.

“Surface area per square meter of projected substrate area” refers to the actual measured surface area, usually measured in square meters, divided to the surface area of the substrate if it were atomically smooth (no surface roughness), also typically in square meters.

“Synergy” or “synergistic” refers to the interaction or cooperation between two or more substances, materials, or agents to produce a combined effect that is greater (positive synergy) or lesser (negative synergy) than the sum of their separate, individual effects.

“Thickness” refers to the length between the surface of the substrate and the top of the surface modification (e.g., ceramic) material.

“Third quartile pore diameter” refers to the value of the pore diameter at which the cumulative pore surface area determined in the direction of increasing pore size is equivalent to 75% of the total cumulative pore surface area as determined by BJH gas adsorption/desorption measurements.

“Tortuosity” refers to the fraction of the shortest pathway through a porous structure Δl and the Euclidean distance between the starting and end point of that pathway Δx.

“Tunable” refers to the ability of a function, characteristic, or quality of a material to be changed or modified.

### Structured Ceramic Materials

A continuous or discrete coating or surface modification material (porous ceramic material that includes an interconnected network of ceramic) as described herein may be a structured ceramic, for example, a binderless (e.g., surface immobilized) ceramic, such as a binderless ceramic with a crystallinity greater than about 20%, e.g., an interconnected network of ceramic material. In some embodiments, the structured ceramic is porous, e.g., an interconnected network of porous ceramic material. Nonlimiting examples of ceramic materials are provided in PCT/US19/65978, which is incorporated herein by reference in its entirety.

The interconnected network of ceramic material may include a metal oxide and/or hydroxide ceramic, for example, a single metal or mixed metal oxide and/or hydroxide ceramic. In some embodiments, the interconnected network of ceramic material includes a metal hydroxide and/or hydroxide ceramic, for example, a single metal or mixed metal oxide and/or hydroxide ceramic. In some embodiments, the interconnected network of ceramic material includes a metal oxide and a metal hydroxide ceramic, wherein the metal oxide and the metal hydroxide include the same or different single metal or mixed metal. In some embodiments, the interconnected network of ceramic material includes a metal oxide and/or a metal hydroxide ceramic, wherein the substrate is hydrated by water or other compounds resulting in a change of surface energy and potentially the ratio of metal oxide to metal hydroxide composition of the ceramic. In some embodiments, the interconnected network of ceramic material includes a metal hydroxide, wherein at least a portion of the metal hydroxide is in the form of a layered double hydroxide, e.g., at least about 5%, 10%, 15%, 20%, 25%, 30%, 35%, 40%, 45%, 50%, 55%, 60%, 65%, 70%, 75%, 80%, 85%, 90%, or 95% of the metal hydroxide is layered double hydroxide.

In some embodiments, a “metal oxide” or “metal hydroxide” may be in the form of a hydrate of a metal oxide or metal hydroxide, respectively, or a portion of the metal oxide or metal hydroxide may be in the form of a hydrate of a metal oxide or metal hydroxide, respectively.

A mixed metal oxide or mixed metal hydroxide may include, for example, oxides or hydroxides, respectively, of more than one metal, such as, but not limited to, iron, cobalt, nickel, copper, manganese, chromium, titanium, vanadium, zirconium, molybdenum, tantalum, zinc, lead, tin, tungsten, cerium, praseodymium, samarium, gadolinium, lanthanum, magnesium, aluminum, or calcium.

In some embodiments, the interconnected network of ceramic material is a binderless ceramic material, i.e., deposited onto a substrate without a binder. In some embodiments, the interconnected network of ceramic material is immobilized on the substrate.

In some embodiments, the interconnected network of ceramic material may be in the form of a metal phosphate, a metal carbonate, a metal sulfate, a metal borate, a metal tungstate, a metal molybdate, a metal titanate, a metal stannate, a metal silicate, and a metal vanadate, or a combination thereof. In some embodiments the material may comprise, but is not limited to, iron, cobalt, nickel, copper, manganese, chromium, titanium, vanadium, zirconium, molybdenum, tantalum, zinc, lead, tin, tungsten, cerium, praseodymium, samarium, gadolinium, lanthanum, magnesium, aluminum, barium, or calcium.

In some embodiments, the interconnected network of ceramic material has an open cell porous structure, for example, characterized by one or more of: ability to effect capillary rise of a liquid having a low surface tension (e.g., less than about 25 mN/m, such as isopropanol) at greater than about 5 mm up a surface against gravity in a closed container in 1 hour; surface area of about 0.1 m²/g to about 10,000 m²/g; mean pore size of about 10 nm to about 1000 nm or about 1 nm to about 1000 nm; pore volume as measured by mercury (Hg) intrusion porosimetry of about 0 to about 1 cc/g; and tortuosity of about 1 to about 1000 as defined by the length of a fluid path to the shortest distance, the “arc-chord ratio”; and/or permeability of about 1 to about 10,000 millidarcy.

The ceramic material is porous, and may have a porosity of about 5% to about 95%. In some embodiments, the porosity may be any of at least about or greater than about 5%, 10%, 15%, 20%, 25%, 30%, 35%, 40%, 50%, 55%, 60%, 65%, 70%, 75%, 80%, 85%, 90%, or 95%. In some embodiments, the porosity is about 10% to about 90%, about 30% to about 90%, about 40% to about 80%, or about 50% to about 70%.

In some embodiments, the porous ceramic material has a permeability of about 1 to 10,000 millidarcy. In some embodiments, the permeability may be any of at least about 1, 10, 100, 500, 1000, 5000, or 10,000 millidarcy. In some embodiments, the permeability is about 1 to about 100, about 50 to about 250, about 100 to about 500, about 250 to about 750, about 500 to about 1000, about 750 to about 2000, about 1000 to about 2500, about 2000 to about 5000, about 3000 to about 7500, about 5000 to about 10,000, about 1 to about 1000, about 1000 to about 5000, or about 5000 to about 10,000 millidarcy.

In some embodiments, the porous ceramic material includes a void volume of about 100 mm³/g to about 7500 mm³/g, as determined by mercury intrusion porosimetry. In some embodiments, the void volume is any of at least about 100, 200, 300, 400, 500, 600, 700, 800, 900, 1000, 1500, 2000, 2500, 3000, 3500, 4000, 4500, 5000, 5500, 6000, 6500, 7000, or 7500 mm³/g. In some embodiments, the void volume is any of about 100 to about 500, about 200 to about 1000, about 400 to about 800, about 500 to about 1000, about 800 to about 1500, about 1000 to about 2000, about 1500 to about 3000, about 2000 to about 5000, about 3000 to about 7500, about 250 to about 5000, about 350 to about 4000, about 400 to about 3000, about 250 to about 1000, about 250 to about 2500, about 2500 to about 5000, or about 500 to about 4000 mm³/g.

A porous ceramic material as disclosed herein may be characterized by its interaction with liquid materials. As previously noted, the ceramic material may be characterized the ability to effect capillary rise of a liquid having a low surface tension (e.g., less than about 25 mN/m, such as isopropanol) at greater than about 5 mm up a surface against gravity in a closed container in 1 hour. Other solvents with surface tension less than about 25 mN/m at 20° C. of may be used including, but not limited to, Perfluorohexane, Perfluoroheptane, Perfluorooctane, n-Hexane (HEX), Polydimethyl siloxane (Baysilone M5), tert-Butylchloride, n-Heptane, n-Octane (OCT), Isobutylchloride, Ethanol, Methanol, Isopropanol, 1-Chlorobutane, Isoamylchloride, Propanol, n-Decane (DEC), Ethylbromide, Methyl ethyl ketone (MEK), n-Undecane, Cyclohexane. Other solvents with surface tension at 20° C. of >25 mN/m may be used including: Acetone (2-Propanone), n-Dodecane (DDEC), Isovaleronitrile, Tetrahydrofuran (THF), Dichloromethane, n-Tetradecane (TDEC), sym-Tetrachloromethane, n-Hexadecane (HDEC), Chloroform, 1-Octanol, Butyronitrile, p-Cymene, Isopropylbenzene, Toluene, Dipropylene glycol monomethylether, 1-Decanol, Ethylene glycol monoethyl ether (Ethyl Cellosolve), 1,3,5-Trimethylbenzene (Mesitylene), Benzene, m-Xylene, n-Propylbenzene, Ethylbenzene, n-Butylbenzene, 1-nitro propane, o-Xylene, Dodecyl benzene, Fumaric acid diethylester, Decalin, Nitroethane, Carbon disulfide, Cyclopentanol, 1,4-Dioxane, 1,2-Dichloro ethane, Chloro benzene, Dipropylene glycol, Cyclohexanol, Hexachlorobutadiene, Bromobenzene, Pyrrol (PY), N,N-dimethyl acetamide (DMA), Nitromethane, Phthalic acid diethylester, N,N-dimethyl formamide (DMF), Pyridine, Methyl naphthalene, Benzylalcohol, Anthranilic acid ethylester, lodobenzene, N-methyl-2-pyrrolidone, Tricresylphosphate (TCP), m-Nitrotoluene, Bromoform, o-Nitrotoluene, Phenylisothiocyanate, α-Chloronaphthalene, Furfural (2-Furaldehyde), Quinoline, 1,5-Pentanediol, Aniline (AN), Polyethylene glycol 200 (PEG), Anthranilic acid methylester, Nitrobenzene, a-Bromonaphthalene (BN), Diethylene glycol (DEG), 1,2,3-Tribromo propane, Benzylbenzoate (BNBZ), 1,3-Diiodopropane, 3-Pyridylcarbinol (PYC), Ethylene glycol (EG), 2-Aminoethanol, sym-Tetrabromoethane, Diiodomethane (DI), Thiodiglycol (2,2′-Thiobisethanol) (TDG), Formamide (FA), Glycerol (GLY), Water (WA), and Mercury

The porous ceramic surface modification material (interconnected network of ceramic) may possess the ability to effect capillary rise of water, at various temperatures. These materials may have the ability to separate miscible materials and binary azeotropes, such as ethanol-water, ethyl acetate-ethanol, or butanol-water, to break ternary azeotropes, or to remove amyl alcohol from mixtures including ethanol and water.

The pores of the porous ceramic surface modification material (interconnected network of ceramic) I may include open cells filled with one or more gas, may include partially filled cells (e.g., partially filled with one or more solid material(s)), or may include completely or substantially filled cells (e.g., completely or substantially filled with one or more liquid and/or solid material(s)). In some embodiments, the pores are partially, substantially, or completely filled with a gas, liquid, or solid substance, or combinations thereof.

In some embodiments, the accessible pore volume of the porous ceramic material is partially filled with a first material and then partially or completely filled with a second material. In some embodiments, the second material is added as a layer of material over partially filled pores. In some embodiments, the first material is a gas, solid, or liquid, or combination of gas, liquid, and/or solid substance(s). In some embodiments, the second material is a gas, solid, and/or liquid substance(s), or the environment (e.g., air). Examples include, and functions thereby imparted include changes in the porosity, wicking, repellency and/or wetting behavior; changes in the composite (comprising the porous material and second material) to modify electrical/dielectric properties, to modify mechanical properties such as abrasion resistance, hardness, toughness, tactile feel, elastic modulus, yield strength, yield stress, Young's modulus, surface (compressive or tensile) stress, and/or elasticity; changes in thermal properties such as thermal diffusivity, conductivity, thermal expansion coefficient, thermal interface stress, and/or thermal anisotropy; modification of optical properties such as emissivity, color, reflectivity, and/or absorption coefficients; modification of chemical properties such as corrosion, catalysis, reactivity, inertness, compatibility, fouling resistance, ion pump blocking, microbial resistance, and/or microbial compatibility; and/or as a substrate for biocatalysis.

In some embodiments, the first material interacts with the second material in a positive or negative synergistic manner to alter one or more functional characteristic of the ceramic material, such as, but not limited to, wettability, hardness, elasticity, a mechanical, electrical, piezoelectric, optical, adhesion, or thermal property, microbial affinity or resistance, alteration of biofilm growth, catalytic activity, permeability, aesthetic appearance, liquid repellency, and/or corrosion resistance.

Nonlimiting materials that may be used to partially or completely fill pores include molecules capable of binding to the surface such as molecules with a head group and a tail group wherein the head group is a silane, phosphonate or phosphonic acid, a carboxylic acid, vinyl, a hydroxide, a thiol, or ammonium compound. The tail group can include any functional group such as hydrocarbons, fluorocarbons, vinyl groups, phenyl groups, and/or quaternary ammonium groups. Other ceramic materials (a second ceramic material) can also be deposited into the pores partially or completely. Polymers may also be deposited into the pores partially or completely. The second ceramic material may include, for example, one or more oxide of zinc, aluminum, manganese, magnesium, cerium, gadolinium, and cobalt. In addition, ceramic materials may include any solid material which can be added to the surface modification material, including an inorganic compound of metal, non-metal, or metalloid atoms primarily held in ionic and covalent bonds, such as, for example, clays, silicas, and glasses. Other ceramics (the second ceramic material) may include a metal phosphate, a metal carbonate, a metal sulfate, a metal borate, a metal tungstate, a metal molybdate, a metal titanate, a metal stannate, a metal silicate, a metal vanadate, or a metal zincate. In some embodiments the second ceramic material may comprise, but not limited to, iron, cobalt, nickel, copper, manganese, chromium, titanium, vanadium, zirconium, molybdenum, tantalum, zinc, lead, tin, tungsten, cerium, praseodymium, samarium, gadolinium, lanthanum, magnesium, aluminum, barium, or calcium. Polymers may include, for example, natural polymeric materials such as hemp, shellac, amber, wool, silk, natural rubber, cellulose, and other natural fibers, sugars, hemi- and holo-celluloses, polysaccharides, and biologically derived materials such as extracellular proteins, DNA, chitin. Synthetic polymers include, for example, polymers and co-polymers containing polyethylene, polypropylene, polystyrene, polyvinyl chloride, synthetic rubber, phenol formaldehyde resin(or Bakelite), neoprene, nylon, polyacrylonitrile, PVB, silicone, polyisobutylene, PEEK, PMMA, and PTFE.

In some embodiments, the accessible pore volume of the porous ceramic material is filled partially with a thin composite polymer layer to produce a surface modification material that has porosity and functionality provided by the polymer. In other embodiments, the pores are filled completely with a thick polymer layer to produce a surface modification material with a thick polymer layer that has composite properties of the porous base material and the polymer layer. A polymer as described in the compositions herein includes co-polymers.

In some embodiments, the accessible pore volume of the porous ceramic material is partially or completely filled with a layer of material deposited over the surface of the surface modification material. In some embodiments, a layer of material is deposited that adds one or more functional group(s) to the surface modification material, such as, but not limited to, ammonium groups (e.g., quaternary ammonium groups), alkyl groups, perfluoroalkyl groups, fluoroalkyl groups. In some embodiments, a polymer or ceramic layer is deposited. In one embodiment, a ceramic top surface layer is deposited which is the same or different ceramic than the ceramic of the binderless porous ceramic material on the substrate. Examples of functional group(s) and functions thereby imparted include quaternary ammonium groups for anti-microbial functions, alkyl chains for water repellency and hydrocarbon affinity, perfluoroalkyl groups for water and oil repellant functions, polymers for mechanical property function, other ceramics for aesthetic functions, optoelectronic functions, or anti-corrosive functions.

In some embodiments, the accessible pore volume of the porous ceramic material is partially or completely filled with a gas, liquid, or solid substance, or combinations thereof, and the composition further includes a layer of a top surface material over the ceramic material, and the top surface material imparts one or more functionality, such as, but not limited to, wettability with a liquid and/or selective separation of compounds in a liquid. In certain embodiments, the top surface material is a separate material from the substance with which the pores are partially, substantially, or completely filled, and does not itself fill or intrude into the pores. In some embodiments, the top surface material interacts with the substance(s) in the pores. For example, the top surface material may interact with the substance(s) in the pores to provide one or more functionality, such as, but not limited to, thermal management, electrochemical reactivity modulation, and/or mechanical property modulation. In certain embodiments, the top surface material is the surrounding environment with which the binderless porous ceramic material is in contact.

In some embodiments, the accessible pore volume of the porous ceramic material is substantially or completely filled with a polymer or with a ceramic material.

In some embodiments, a material in the pores interacts with the ceramic material. Examples of such materials and functions thereby imparted include the oxidation of the surface modification material by ambient liquid or vapor, the condensation of minor components (e.g., environmental pollutants), the capture or oxidation of hazardous environmental materials such as CO or H₂S from environmental air, and/or the collection and retention of materials in the environment.

In some embodiments, moisture in the environment or added to the pores interacts with a material in the pores to modify the material in the pores or the surface modification material. Examples of such materials and functions thereby imparted include changes in wetting behavior, in optical properties, changes in oxidation state or reactivity, changes in the rate of evaporation, frosting, icing, or condensation.

In some embodiments, material in the pores may be designed to interact with the ceramic material to “tune” the properties of the overall surface. Examples of tunable properties includes, but are not limited to, wettability, hardness, microbial resistance, catalytic activity, corrosion resistance, color, and/or photochemical activity.

In some embodiments, the ceramic surface modification material (interconnected network of ceramic) and a material in the pores interact in a synergistic manner, for example, enhancing or reducing at least one functionality of the surface modification material and/or the material in the pores, in comparison to the functionality of the surface modification material and/or the material in the pores alone. In some embodiments, two or more materials in the pores interact in a synergistic manner, for example, enhancing or reducing at least one functionality of at least one material in the pores, in comparison to the functionality of that material alone.

In some embodiments, the ceramic surface modification material (interconnected network of ceramic) is asymmetric, for example, a pore morphology that is not spherical, cylindrical, cubic or otherwise ordered as having a well-defined, relatively constant, normal distribution of surface area to volume, as characterized a by a ratio of the pore diameter at the first quartile to the pore size at the third quartile as a function of the thickness of the binderless ceramic surface modification. In particular, the pore morphology is asymmetric about its center when compared to a spherical, cylindrical, or cubic structure. A nonlimiting example of asymmetric pores is depicted in PCT Application No. PCT/US19/39743, which is incorporated by reference herein in its entirety.

A porous ceramic surface modification material (interconnected network of ceramic) may be characterized by a broad pore size distribution that varies with distance from the substrate. In particular, the pore structure at a given distance from the substrate can be characterized locally, e.g., as described herein and has a different characterization at a different distance. The resulting asymmetry is determined in situ by the combination of substrate, ionic mobility, processing conditions such as temperature, pressure, and concentrations. The degree of asymmetry can be further modified through bulk means such as mixing, agitation, electric field modulation, and tank filtration, or through surface directed process means such as shear rates, impinging flows or surface charge modification and modulation. The asymmetry can be determined ex situ through a variety of means such as etching, track etching, ion beam milling, oxidation, photocatalysis, or through additional means. These approaches are to refer to materials which have a narrower, or symmetric pore structures, with thickness and/or pore depth, such as zeolites, track etched membranes, or expanded PTFE membranes.

In some embodiments, the porous ceramic surface modification material (interconnected network of ceramic) includes mesoporous mean pore sizes that range from about 2 nm to about 50 nm. In other embodiments, the mean pore sizes range from about 50 nm to about 1000 nm. In some embodiments, the binderless porous ceramic material includes a mean pore diameter of about 2 nm to about 20 nm. In some embodiments, the mean pore diameter is any of at least about 2, 3, 4, 5, 6, 7, 8, 9, 10, 11, 12, 13, 14, 15, 16, 17, 18, 19, or 20 nm. In some embodiments, the mean pore diameter is any of about 2 to about 5, about 4 to about 9, about 5 to about 10, about 7 to about 12, about 9 to about 15, about 12 to about 18, about 15 to about 20, about 4 to about 11, about 5 to about 9, about 4 to about 8, or about 7 to about 11 nm.

The ceramic surface modification material (interconnected network of ceramic) may include one or more metal oxide and/or metal hydroxide (and/or hydrates thereof). Non-limiting examples of metals that may be included in the ceramic compositions disclosed herein include: zinc, aluminum, manganese, magnesium, cerium, copper, gadolinium, tungsten, tin, lead, and cobalt. In some embodiments, the ceramic material includes a transition metal, a Group II element, a rare-earth element (e.g., lanthanum, cerium gadolinium, praseodymium, scandium, yttrium, samarium, or neodymium), aluminum, tin, or lead. In some embodiments, the ceramic material includes two or more metal oxides (e.g., a mixed metal oxide) including but not limited to zinc, aluminum, manganese, magnesium, cerium, praseodymium, and cobalt.

In some embodiments, the ceramic surface modification material (interconnected network of ceramic) includes: a mixture of zinc and aluminum oxides and/or hydroxides; a mixture of ZnO and Al₂O₃, and Zn-aluminates; mixtures of materials comprising any/all phases comprising Zn, Al, and oxygen; a mixture of manganese and magnesium oxides and/or hydroxides; manganese oxide; aluminum oxide; a mixed metal manganese oxide and/or hydroxide; a mixture of magnesium and aluminum oxides and/or hydroxides; a mixture of magnesium, cerium, and aluminum oxides and/or hydroxides; a mixture of zinc, gadolinium, and aluminum oxides and/or hydroxides; a mixture of cobalt and aluminum oxides and/or hydroxides; a mixture of manganese and aluminum oxides and/or hydroxides; a mixture of cerium and aluminum oxides and/or hydroxides; a mixture of iron and aluminum oxides and/or hydroxides; a mixture of tungsten and aluminum oxides and/or hydroxides; a mixture of tin and aluminum oxides; tungsten oxide and/or hydroxide; magnesium oxide and/or hydroxide; manganese oxide and/or hydroxide; tin oxide and/or hydroxide; or zinc oxide and/or hydroxide.

In some embodiments, at least one metal in the interconnected network of ceramic material is in the 2⁺ oxidation state.

In some embodiments, the ceramic surface modification material (interconnected network of ceramic) includes one or more oxide and/or hydroxide of zinc, aluminum, manganese, magnesium, cerium, gadolinium, and cobalt, and the substrate is aluminum or an aluminum alloy.

In some embodiments, the ceramic surface modification material (interconnected network of ceramic) is superhydrophobic. In some embodiments, the surface modification material is highly hydrophobic. In some embodiments, the surface modification material includes one or more functional characteristic selected from wettability, hardness, elasticity, mechanical, electrical, piezoelectric, electromagnetic, optical, adhesion, or thermal properties, microbial affinity or resistance, alteration of biofilm growth, catalytic activity, permeability, aesthetic appearance, and corrosion resistance, in comparison to a substrate that does not include the ceramic material.

In some embodiments, a functional material layer (e.g., top layer of material) is deposited onto the interconnected network of ceramic material. Examples of such materials include, but are not limited to, quaternary ammonium groups for anti-microbial functions, alkyl chains for water repellency and hydrocarbon affinity, perfluoroalkyl groups for water and oil repellant functions, polymers for mechanical property function, other ceramics for aesthetic functions, optoelectronic functions, or anti-corrosive functions. Examples of functionalities imparted by such materials include, but are not limited to, —changes in the porosity, wicking, repellency, and/or wetting behavior; changes in the composite (including the porous material and second material) to modify electrical/dielectric properties, to modify mechanical properties such as abrasion resistance, hardness, toughness, tactile feel, elastic modulus, yield strength, yield stress, Young's modulus, surface (compressive or tensile) stress, tensile strength, compression strength, and/or elasticity; thermal properties such as thermal diffusivity, conductivity, thermal expansion coefficient, thermal interface stress, thermal anisotropy, to modify optical properties such as emissivity, color, reflectivity, and/or absorption coefficients, to modify of chemical properties such as corrosion, catalysis, reactivity, inertness, compatibility, fouling resistance, ion pump blocking, microbial resistance and/or microbial compatibility, promotion of adhesion of subsequent material layers, and/or as a substrate for biocatalysis.

In some embodiments, the ceramic surface modification material (interconnected network of ceramic) is resistant to degradation by ultraviolet radiation, in comparison to the substrate material, such as a polymer or any of the substrate materials disclosed herein.

In some embodiments, the ceramic surface modification material (interconnected network of ceramic) includes a thickness of about 0.5 micrometers to about 20 micrometers. In some embodiments, the ceramic material includes a thickness of about 0.2 micrometers to about 25 micrometers. In some embodiments, the thickness is any of at least about 0.2, 0.5, 1, 2, 3, 4, 5, 6, 7, 8, 9, 10, 11, 12, 13, 14, 15, 16, 17, 18, 19, 20, 21, 22, 23, 24, or 25 micrometers. In some embodiments, the thickness is any of about 0.2 to about 0.5, about 0.5 to about 1, about 1 to about 5, about 3 to about 7, about 5 to about 10, about 7 to about 15, about 10 to about 15, about 12 to about 18, about 15 to about 20, about 18 to about 25, about 0.5 to about 15, about 2 to about 10, about 1 to about 10, about 3 to about 13, about 0.5 to about 15, about 0.5 to about 5, about 0.5 to about 10, or about 5 to about 15 micrometers.

In some embodiments, the ceramic surface modification material (interconnected network of ceramic) is characterized by a water contact angle of about 0° to about 180°. In other embodiments, the water contact angle is less than about 30 degrees. In other embodiments the water contact angle is greater than about 150 degrees.

In some embodiments, the ceramic surface modification material (interconnected network of ceramic) includes a surface area of about 1.1 m² to about 100 m² per square meter of projected substrate area. In some embodiments, the ceramic material includes a surface area of about 10 m² to about 1500 m² per square meter of projected substrate area. In some embodiments, the surface area is any of at least about 10, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, or 1500 m² per square meter of projected substrate area. In some embodiments, the surface area is any of about 10 to about 100, about 50 to about 250, about 150 to about 500, about 250 to about 750, about 500 to about 1000, about 750 to about 1200, about 1000 to about 1500, about 70 to about 1000, about 150 to about 800, about 500 to about 900, or about 500 to about 1000 m² per square meter of projected substrate area.

In some embodiments, the ceramic material (interconnected network of ceramic) includes a surface area of about 15 m² to about 1500 m² per gram of ceramic material. In some embodiments, the surface area is any of at least about 15, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, or 1500 m² per gram of ceramic material. In some embodiments, the surface area is any of about 15 to about 100, about 50 to about 250, about 150 to about 500, about 250 to about 750, about 500 to about 1000, about 750 to about 1200, about 1000 to about 1500, about 50 to about 700, about 75 to about 600, about 150 to about 650, or about 250 to about 700 m² per gram of ceramic material.

### Substrates

The substrate on which a porous ceramic material that includes an interconnected network of ceramic as described herein are applied or deposited may be composed of any material suitable for the structural or functional characteristics, or functional application of use, for example, in a device, such as a heat exchanger. In some embodiments, the substrate is aluminum or contains aluminum (e.g., an aluminum alloy), a ferrous alloy, zinc, a zinc alloy, copper, a copper alloy, a nickel alloy, nickel, a titanium alloy, titanium, a cobalt-chromium containing alloy, glass, a polymer, a co-polymer, a natural material (e.g., a natural material containing cellulose), or a plastic.

In some embodiments, the substrate includes a metal, and the primary metal in a ceramic surface modification material as described herein is different than the primary metal in the substrate. A primary metal is a metal that is at least about 50%, 60%, 70%, 80%, 90%, or 95% of the total metal in the substrate or the ceramic material, e.g., as determined by x-ray diffraction on an atomic metals basis. Examples of substrate primary metals include, but are not limited to, aluminum, iron, copper, zinc, nickel, titanium, and magnesium. Examples of ceramic primary metals include, but are not limited to, zinc, aluminum, manganese, magnesium, cerium, copper, gadolinium, tungsten, tin, lead, and cobalt.

In some embodiments, the substrate includes a metal that is able to react (e.g., dissolve) under reaction conditions that allow for local dissolution of the substrate metal, and the substrate metal is incorporated into a substrate modification material, such as a ceramic material, e.g., a binderless porous ceramic material. For example, an aluminum substrate may provide aluminum (e.g., Al²⁺) that is incorporated into ceramic material as the ceramic material is deposited on the substrate.

In some embodiments, the substrate is a particle, powder, extrudate, pellet, flake, or lobed (e.g., bilobe, trilobe, quadrilobe, etc.) structure. In some embodiments the substrate is a metallic particle, powder, extrudate, pellet, flake or lobed structure wherein the deposited binderless ceramic interconnected network is deposited on the surface of the substrate.

In some embodiments, the substrate is a ceramic material. In some embodiments, the substrate comprises a ceramic material. In some embodiments, the ceramic material is an oxide ceramic, a non-oxide ceramic, or a combination thereof. In some embodiments, the ceramic material comprises an oxide ceramic, a non-oxide ceramic, or a combination thereof. In some embodiments, the ceramic material consists of one or more oxide ceramics, one or more non-oxide ceramics, or a combination thereof. In some embodiments, the ceramic material consists of one or more oxide ceramics. In some embodiments, the ceramic material consists of one or more non-oxide ceramics. In some embodiments, the ceramic material comprises an oxide ceramic. In some embodiments, the oxide ceramic is an oxide, a hydroxide, a mixed oxide/hydroxide, an aluminate, a silicate, a titanate, a zirconate, a tungstate, or mixtures thereof. In some embodiments, wherein the oxide ceramic is a mixed oxide/hydroxide, the ratio of oxide:hydroxide is a function of the degree of hydration of the mixed oxide/hydroxide. In some embodiments, the oxide ceramic is aluminum oxide (alumina), silicon oxide (silica), silica-alumina, cerium oxide (ceria), yttrium oxide (yttria), titanium oxide (titania), zirconium oxide (zirconia), hafnium oxide (hafnia), molybdenum oxide, tungsten oxide, tin oxide, or a combination thereof. In some embodiments, the oxide ceramic is alumina, silica, or silica-alumina. In some embodiments, the oxide ceramic is alumina. In some embodiments, the oxide ceramic is silica. In some embodiments, the oxide ceramic is silica-alumina. In some embodiments, the oxide ceramic is titania, zirconia, hafnia, or a combination thereof. In some embodiments, the oxide ceramic is titania. In some embodiments, the oxide ceramic is zirconia. In some embodiments, the oxide ceramic comprises an alkali metal oxide/hydroxide, an alkaline earth metal oxide/hydroxide, or a combination thereof. In some embodiments, the oxide ceramic comprises sodium oxide/hydroxide or potassium oxide/hydroxide. In some embodiments, the oxide ceramic comprises dipotassium oxide. In some embodiments, the oxide ceramic comprises disodium oxide. In some embodiments, the oxide ceramic is magnesium oxide (magnesia) or calcium oxide. In some embodiments, the oxide ceramic is magnesium oxide. In some embodiments, the oxide ceramic is magnesium aluminate or calcium aluminate. In some embodiments, the oxide ceramic is an alkali metal silicate, magnesium silicate, calcium silicate, aluminum silicate, zirconium silicate, or a combination thereof. In some embodiments, the oxide ceramic is magnesium titanate or aluminum titanate. In some embodiments, the oxide ceramic is aluminum zirconate, magnesium zirconate, or calcium zirconate. In some embodiments, the oxide ceramic is a zeolite. In some embodiments, the ceramic material comprises a non-oxide ceramic. In some embodiments, the non-oxide ceramic is a carbide, a nitride, or an oxy-nitride. In some embodiments, the non-oxide ceramic is a nitride ceramic, or a carbide ceramic. In some embodiments, the non-oxide ceramic is boron nitride, aluminum nitride, silicon nitride, boron carbide, silicon carbide, titanium carbide, tungsten carbide, molybdenum carbide, or a combination thereof. In some embodiments, the non-oxide ceramic is silicon aluminum oxy-nitride.

In some embodiments, the substrate comprises a ceramic material. In some embodiments, the ceramic material comprises an oxide ceramic. In some embodiments, the oxide ceramic comprises a sulfated oxide. In some embodiments, the sulfated oxide is sulfated titania, sulfated zirconia, or sulfated tin oxide.

In some embodiments, the substrate comprises a ceramic material. In some embodiments, the ceramic material comprises an oxide ceramic. In some embodiments, the oxide ceramic comprises an alkali metal halide, an alkaline earth metal halide, or a combination thereof. In some embodiments, the oxide ceramic comprises sodium chloride, potassium chloride, potassium bromide, calcium chloride, magnesium chloride, or a combination thereof. In some embodiments, the oxide ceramic comprises magnesium chloride.

In some embodiments, the substrate is formed. In some embodiments, the substrate is a formed ceramic material. In some embodiments, the formed ceramic material is in the form of a pellet, a sphere, a ring, a cylinder, a honeycomb, a trilobe, or a quadrilobed. In some embodiments, the formed ceramic material is in the form of a pellet. In some embodiments, the formed ceramic material is in the form of a sphere. In some embodiments, the formed ceramic material is in the form of a ring. In some embodiments, the formed ceramic material is in the form of a cylinder. In some embodiments, the formed ceramic material is in the form of a honeycomb. In some embodiments, the formed ceramic material is in the form of a trilobe. In some embodiments, the formed ceramic material is in the form of a quadrilobe. In some embodiments, the formed ceramic material is an extrudate. In some embodiments, the extrudate is from about 0.5 mm to about 5 mm in diameter, from about 0.5 mm to about 4 mm in diameter, from about 0.5 mm to about 3 mm in diameter, from about 0.5 mm to about 2 mm in diameter, from about 0.5 mm to about 1 mm in diameter, from about 1 mm to about 5 mm in diameter, from about 1 mm to about 4 mm in diameter, from about 1 mm to about 3 mm in diameter, or from about 1 mm to about 2 mm in diameter. In some embodiments the formed ceramic material is in a random or loose packing configuration such as saddles, heli-pak, or Raschig rings. In some embodiments the formed ceramic material is in a mesh configuration, In some embodiments the formed ceramic material is in a structured packing configuration.

### Conversion of Metal Oxides

Products formed as the result of a chemical conversion of a ceramic surface modification (e.g., a porous metal oxide and/or hydroxide ceramic surface modification, e.g., interconnected network of porous metal oxide and/or hydroxide ceramic) are provided herein. The conversion products described herein impart one or more property to the substrate, which may be the same or different than property(ies) imparted by the original ceramic surface modification. The benefits provided by a conversion product have broad applicability. The product formed is a modification of the original metal oxide and/or hydroxide ceramic material, including, but not limited to a metal oxide/hydroxide, a metal phosphate, a metal carbonate, a metal sulfate, a metal borate, a metal tungstate, a metal molybdate, a metal titanate, a metal stannate, a metal silicate, or a metal vanadate.

In some embodiments, the conversion can impart additional corrosion resistance, shift the surface isoelectric point or point of zero charge, protect against acids or bases, modulate the optical properties to absorb, reflect, or emit in different frequencies, inhibit membrane plasma ATPases, provide ferroelectric properties, increase the capacitance or improve the dielectric performance, modulate the temperature coefficient of resistance, increase thermal stability, impart piezoelectric properties, increase the surface area, aid in adsorption, change colors upon certain chemical reactions, increase ultraviolet (UV) resistance, and/or impart pseudocapacitive properties, in comparison to an identical ceramic material that does not include the conversion.

In one embodiment, the conversion provides a reduced substrate susceptibility to corrosion. In a nonlimiting example, the substrate is protected by an inert metal phosphate or metal carbonate barrier from corrosive environments and/or chemicals. This protective layer may act in two main ways to prevent corrosion and/or reduction of electrical conductivity of the substrate. The primary protection is physical, with the inert barrier preventing corrosive species from attacking the substrate and reducing electrical conductivity. The secondary function of the metal phosphate layer is to act as a sacrificial element to react with corrosive species instead of the substrate.

### Applications of Use

In some embodiments, the modified substrate is a coated article and is used as coated or after being installed into a system, such as a heat exchanger, reactor or distillation column. In other embodiments, the coated substrate could be used as an additive, such as modified particles, powder, extrudates, or flakes, for example, in a thermal paste or polymer-ceramic composite. In other embodiments the modified substrate could be processed into a bulk component, such as by sintering (e.g., laser sintering), melt casting, injection molding, or 3-D printing (e.g., fused deposition modeling (FDM) 3-D printing) of the coated substrate or a composite of the coated substrate. In some embodiments, the coated substrate is a surface modified ceramic particle, power, extrudate, pellet, flake, or lobed structure that is sintered together (e.g., using laser sintering) resulting in a metal-ceramic composite. In some embodiments, such as reactor or distillation packing, the modified substrates may be formed into a structural shape such as, but not limited to, a saddle, and subsequently joined (e.g., sintered) into a larger component used in a system. In some embodiments, the modified substrates may be formed into a structural shape that is used as a mold for filling for a larger component used in a system. In some embodiments, this metal-ceramic composite comprises magnesium and aluminum oxides. In other embodiments sintering (e.g., laser sintering, uniaxial hot pressing, hot isostatic pressing), melt casting, or injection molding of modified particles, power, extrudate, pellets, or flakes results in a ceramic monolith. In some embodiments, this ceramic monolith has a theoretical density of greater than about 80%, greater than about 90%, or greater than about 95%. In some embodiments, this ceramic monolith comprises magnesium-aluminum spinel, aluminum titanate, zinc-aluminum spinel, or comprises silicon, aluminum, magnesium, zirconium, titanium, or calcium.

In some embodiments the post-processing of ceramic modified metal particles, powder, extrude, pellets, or flakes results in an optically transparent monolith. In some embodiments, this monolith can be used as a screen or window. In some embodiments, the post-processing of ceramic modified metal particles, powder, extrudates, pellets or flakes results in a metal-ceramic composite with increased yield strength, toughness, and/or hardness relative to a solid metal without the ceramic.

In some embodiments, within the post-processed ceramic-metal composite, the ceramic forms an interconnected network throughout a monolithic solid. In some embodiments, during sintering (e.g., laser sintering), casting (e.g., melt casting), or molding (e.g., injection molding), the metal substrate particles, powders, extrudates, or flakes melt and flow within or through the porous, interconnected ceramic coating, resulting in a solid object. In some embodiments, this post processing can result in net-shape manufactured parts. In other embodiments, the coated particles, powders, or extrudes can be melt cast into films. In some embodiments, the films are optically transparent.

In some embodiments, the substrate particle size can be selected to determine the ratio of metal to ceramic in the post processed part. In some embodiments this can result in a metal-ceramic composite. In other embodiments this can result in a ceramic. In other embodiments, the post-processed part is more than about 10% ceramic, more than about 20% ceramic, more than about 30% ceramic, more than about 40% ceramic, more than about 50% ceramic, more than about 60% ceramic, more than about 70% ceramic, more than about 80% ceramic, more than about 90% ceramic, more than about 95% ceramic, more than about 99% ceramic.

In some embodiments, a part that includes the ceramic surface modification can be processed at a lower temperature than other manufacturing techniques. In some processing techniques, the substrate melts and reacts with the porous ceramic coating. In some embodiments, this reaction forms a refractory material. In some embodiments, the ceramic coating modulates the optical properties of the substrate, resulting in improved post-processing.

The following examples are intended to illustrate, but not limit, the invention.

### EXAMPLES

The substrates or assembles to which a porous ceramic material as described in the example below is applied typically go through a process starting with a (a) surface preparation or cleaning, followed by (b) a structured ceramic deposition, and (c) the deposition of another ceramic layer or conversion of the deposited structured ceramic layer.
(a) Surface preparation and cleaning step: In the examples below, the surface was prepared as follows. The metallic substrates or assemblies were pot cleaned or wiped with isopropyl alcohol (IPA) and a towel to remove any residual oils. Next, the parts were submerged in a caustic etch bath at pH >10 at a nominal room temperature of 20° C. until a darkening of the surface was observed, or about 15 minutes. The substrates or assemblies were then rinsed in water to remove any residual caustic or loosely adhered material. Next, the parts were submerged in a nitric acid solution with pH below 3 and temperature of 20° C. to remove smut, etch reaction products, intermetallics and surface oxide, or to pickle the substrate, revealing a clean surface. Other surface preparation techniques that result in a clean surface are appropriate and are applicable. Polymeric and cellulosic substrates were pot cleaned or wiped with isopropyl alcohol on a towel to remove any residue.
(b) Structured ceramic deposition: Structured ceramic depositions in the following examples are considered continuous unless otherwise described. Selective coverage was carried out through a partial chemical exposure and/or through the use of masking agents. The substrates or assemblies were then placed into the structured ceramic deposit bath containing 20-500 mM metal nitrate and a similar amount of an amine (such as ethylene diamine, hexamethylenetetramine, or urea), and were allowed to react prior to the substrate insertion at a reaction temperature of 30° C.-90° C. The assemblies were maintained in the bath until the turbidity dropped below 100 NTU or for about 5 minutes to about 90 minutes. The substrates or assemblies were removed, drained, rinsed, and placed into an oven to dry and/or calcine at approximately 100° C.-800° C. for several hours. The parts were then allowed to cool to room temperature.
(c) Deposition of a second ceramic or conversion of the deposited structured ceramic: Structural ceramics created in (b) were dried prior to a post processing step, such as a conversion of the deposited ceramic or deposition of a second ceramic that partially or completely fills the porous interconnected ceramic network with a second material, unless otherwise indicated. Process times between application and subsequent processing were less than 24 h unless otherwise noted.

### Example 1

A phosphate-based corrosion protection layer was created by converting a metal (magnesium) oxide interconnected ceramic surface modification prepared on substrate panels as described above. A 3003 aluminum alloy substrate that had been previously modified with a magnesium oxide structured ceramic surface (using magnesium nitrate and hexamethylenetetramine) was immersed in an aqueous phosphate conversion bath. The phosphate conversion occurred in a heated aqueous solution heated between 50° C. and 90° C. This solution requires three primary components: A=phosphate source, B=buffering species, C=catalyst. Component A may be phosphoric acid or an alkali phosphate salt with a concentration no more than 0.250M. Component B may be an appropriate buffering agent such as acetic acid and its conjugate base salts or citric acid and its conjugate base salts with a concentration no more than 0.150M. Component C is a stannate salt, such as hexahydrostannate, with a concentration no more than 0.1M. An appropriate combination of components A, B, and C must be chosen in such a way to obtain a pH between 6 and 8.5.

These panels were tested for electrochemical impedance in a neutral 3.5% NaCl solution, where the impedance was found to be, on average, an order of magnitude higher than that of the unconverted surface modification. Samples were assessed in an acidic salt fog test according to ASTM G85 A3 for 94 hours alongside unconverted samples. The amount of pitting observed in on phosphate samples, compared to unconverted surface modified samples, is reduced. The chemical composition post conversion, observed via X-ray fluorescence (XRF) exhibited an increase in phosphorous content from 0% to 30±7% and in tin content from 0% to 0.5±0.2%. Fourier Transform Infrared (FTIR) spectroscopy, suggests P—O bonds are present.

### Example 2

A carbonate-based corrosion protection layer was created by converting a metal oxide interconnected ceramic surface modification prepared on a substrate as described above. An aluminum alloy substrate that had been previously modified with magnesium oxide structured ceramic was immersed in an aqueous carbonate conversion bath. The carbonate conversion occurred in a heated aqueous solution between 50° C. and 90° C. This solution requires one component comprising the carbonate source. This may be a carbonate salt, such as potassium carbonate, sodium bicarbonate, ammonium bicarbonate, or a source to create carbonic acid in solution such as bubbled carbon dioxide. The carbonate concentration is between 0.01M and 1M and optimal immersion time from 600 to 1500 minutes.

In one particular case, a 125 mM carbonation solution of NaHCO₃ in deionized (DI) water, was prepared and heated to 80° C. and equilibrated for 1 hour. The substrate with a magnesium oxide structured deposit was immersed in the carbonation solution for 16 hours, and water was added to maintain liquid level. The sample was removed and dried.

Surface structural changes from the carbonate-based conversion were observed using SEM. The presence of a carbonate compound on the surface was confirmed by the strong IR transmittance peak at 1408 cm⁻¹.

Samples were also assessed in an acidic salt fog test according to ASTM G85 A3 for 94 hours alongside unconverted samples. The amount of observed pitting was reduced when compared to the bare panel substrate materials.

When the sample was analyzed using X-ray diffraction (XRD), chemical compounds in the sample included magnesium hydroxide, aluminum hydroxide, and the carbonate containing mineral hydrotalcite.

### Example 3

A hydroxyapatite, octacalcium phosphate, tricalcium phosphate corrosion protection layer is created by converting an interconnected metal oxide ceramic structured ceramic prepared on a substrate as described above to a form of calcium phosphate. The surface modified substrate is immersed in an aqueous bath containing a calcium salt, such as calcium chloride or calcium nitrate, a phosphate salt, such as potassium hydrogen phosphate, and a chelating/complexing agent, such as urea, hexamethylenetetramine, or ethylenediaminetetraacetic acid. All components are at a concentration ranging from 0.01M to 1M. The conversion occurs in a heated aqueous solution between 50° C. and 90° C., with immersion time from 60 to 1500 minutes. Following immersion, thermal annealing occurs at temperatures from 200° C. to 600° C. for 60 to 1500 minutes.

### Example 4

A hydroxyapatite, octacalcium phosphate, tricalcium phosphate corrosion protection layer is created by depositing an interconnected ceramic comprising calcium phosphate directly onto a substrate. The substrate is immersed in an aqueous bath containing a calcium salt such as calcium chloride or calcium nitrate, a phosphate salt, such as potassium hydrogen phosphate, and a chelating/complexing agent, such as urea, hexamethylenetetramine, or ethylenediaminetetraacetic acid. All components are at a concentration ranging from 0.025M to 1M. The conversion occurs in a heated aqueous solution between 50° C. and 90° C., with immersion time from 60 to 1500 minutes. Following immersion, thermal annealing occurs at temperatures from 200° C. to 600° C. for 60 to 1500 minutes.

### Example 5

A mixed metal ceramic surface modification is created by converting an interconnected metal oxide structured ceramic prepared on a substrate as described above. The surface modified substrate is immersed in an aqueous conversion bath to introduce an anionic form of another metal. The anions serve as a source of corrosion inhibition. The anion sources are salts of certain oxyanions, such as sodium stannate, sodium tungstate, sodium molybdate, or phosphyloxyanion salts, such as sodium phosphotungstate or sodium phosphomolybdate. The aqueous solution may contain a buffering agent to stabilize the ions and surface modification while in solution. The buffering agent may include a citric acid system, a phosphoric acid system, a carbonate system, an acetate system, or a common biological buffer such as tris(hydroxymethyl)aminomethane (Tris) or 3-(N-morpholino)propanesulfonic acid (MOPS). The components of the solution are at a concentration from 0.01M to 1M. Immersion is at a temperature between 50° C. and 90° C., with an immersion time from 5 to 1500 minutes. Following immersion, thermal annealing occurs at temperatures from 200° C. to 600° C. for 60 to 1500 minutes.

### Example 6

A mixed metal ceramic surface modification was created by converting an interconnected magnesium oxide ceramic surface modification prepared on a substrate as described above. The surface modified substrate was immersed in an aqueous conversion bath comprising sodium molybdate to introduce an anionic form of molybdenum. The sodium molybdate serves as a corrosion inhibitor when infused within the ceramic matrix. The sodium molybdate was present in the solution at concentrations from 0.01M to 500 mM, typically about 100 mM, and was held at temperatures ranging from 20° C. to 90° C., typically about 20° C. Immersion times were between 60 and 1500 minutes, typically about 120 minutes. After the conversion step, the sample was rinsed thoroughly under flowing de-ionized water to remove any solution from the surface. The sample was then dried at temperatures between 20° C. to 105° C. EDS and XRF measurements taken after the conversion at both 20° C. and 80° C. conversion bath temperatures showed the presence of molybdenum on the surface of the material. The structure of the interconnected magnesium oxide surface modification and the interconnected molybdenum converted magnesium oxide surface modification were similar when viewed through a scanning electron microscope (SEM).

### Example 7

A mixed metal ceramic surface modification was created by converting a magnesium oxide interconnected ceramic surface modification prepared on a substrate as described above. The surface modified substrate was immersed in an aqueous conversion bath comprising sodium molybdate to introduce an anionic form of molybdenum. The sodium molybdate serves as a corrosion inhibitor when infused within the ceramic matrix. The sodium molybdate was present in the solution at concentrations from 0.01M to 500 mM, typically about 100 mM and was held at temperatures ranging from 20° C. to 90° C., typically about 20° C. Immersion times were between 60 and 1500 minutes, typically about 120 minutes. After the conversion step, the sample was rinsed thoroughly under flowing de-ionized water to remove any solution from the surface. The sample was then thermally annealed at temperatures between 400° C. to 600° C. for 60 to 1500 minutes, typically about 120 minutes. EDS and XRF measurements taken after both 20° C. and 80° C. conversion showed the presence of molybdenum on the surface of the material. Measurements taken with EDS and XRF before the conversion step did not identify molybdenum on the surface of the material. The interconnected structure of the magnesium oxide surface modification and the interconnected molybdenum converted magnesium oxide surface modification were similar when viewed with an SEM.

### Example 8

A mixed metal ceramic surface modification was created by converting an interconnected magnesium oxide structured ceramic surface modification prepared on a substrate as described above. The surface modified substrate was immersed in an aqueous conversion where an anionic form of tin was introduced. The anions serve as a source of corrosion inhibition. Sodium stannate was added to an aqueous bath. The pH of the solution was controlled between 7 and 13, typically around 8 to 9, through the addition of 1M nitric acid. A buffering agent was optionally added to help maintain the pH of the solution and stabilize the ions in solution. The components of the solution are at a concentration from 0.01M to 1M, typically about 100 mM. Immersion was at a temperature between 20° C. and 90° C., typically 20° C., with an immersion time from 5 to 1500 minutes, typically about 900 minutes. Following immersion, the samples were thoroughly rinsed with de-ionized water to remove any of the aqueous solution from the surface. The samples were allowed to dry at temperatures between 15° C. to 105° C. After the samples were dried, they were analyzed with EDS and XRF where tin was identified in the ceramic structure for conversion bath exposure at 20° C. and 80° C. Additionally, the interconnected structure of the ceramic surface modification was similar when imaged using an SEM before and after the immersion in the sodium stannate bath.

### Example 9

A mixed metal ceramic surface modification was created by converting an interconnected magnesium oxide structured ceramic surface modification on an aluminum substrate to a mixed tin and magnesium oxide surface modification on an aluminum substrate. The interconnected structured magnesium oxide surface modified substrate was prepared as described above. At the conclusion of this step, the surface of the interconnected magnesium oxide surface modified aluminum substrate appeared white. The interconnected magnesium surface modified substrate was then immersed in a sodium stannate solution of between 0.005 and 1M, typically about 100 mM. The pH of the solution was controlled to between 7 and 13, typically about pH 12, with the addition of 1M nitric acid. A buffering agent was optionally added to help maintain the pH of the solution and stabilize the ions in solution. The solution was controlled at temperatures between 15° C. and 90° C., typically about 20° C. with an immersion time between 60 minutes and 1500 minutes, typically about 120 minutes. The sample was gently rinsed with de-ionized water to clean the surface of the solution post removal. An optional thermal annealing step occurred at temperatures between 200° C. and 600° C., typically about 4000, for 60 to 1500 minutes, typically about 120 minutes. At the conclusion of both the 20° C. and 80° C. conversion step, the appearance of the mixed metal ceramic surface modification was a silvery metallic. At the conclusion of the thermal annealing step, the color of the surface became dark grey. After the conversion step, the atomic composition of the sample surface processed at 20° C. via energy dispersive X-ray spectroscopy (EDS) was 1.31% Mg, 17.65% Sn, 3.17% Al, 77.53% 0 and trace amounts of sodium. The atomic composition of the sample surface processed at 80° C. via EDS was 14.1% Sn, 85.0% 0 and trace amounts of Al, Mg, and Na. The surface of both samples were interconnected and exhibited nano-scale roughness as determined by SEM imaging.

### Example 10

A low temperature (<100° C.) thermochromically active surface modification was created by converting an interconnected magnesium oxide structured ceramic surface modification prepared on a substrate as described above. The magnesium oxide structured surface modification was white in color after the thermal annealing step. The surface modified substrate was immersed in an aqueous conversion bath to convert the original ceramic metal oxide into mixed metal oxide which contained a thermochromicially active metal oxide. The immersion bath contained an aqueous solution of sodium metavanadate at concentrations between 10 and 200 mM, typically about 100 mM. The aqueous solution was maintained at pH 3-7 with the addition of 1M nitric acid and optionally contained a buffer, such as a citric acid system, phosphoric acid system, carbonate system, acetate system, or a common biological buffer such as tris or MOPS. After pH dosing, the solution turned a bright orange color signifying the presence of decavanadate ions. All components were at a concentration ranging from 0.01M to 200 mM. The conversion occurred in an aqueous solution maintained between 20° C. and 90° C., typically either 20° C., with immersion time from 60 to 1500 minutes, typically about 120 minutes. Following immersion, the sample was thoroughly rinsed with de-ionized water and the sample was allowed to dry. After the substrate was removed from the immersion bath at 20° C. and 80° C., the color of the surface was a yellow-orange color signaling the presence of vanadium compounds on the surface. EDS showed that the atomic composition of the surface processed at 20° C. was 23.7% Al, 9.6% Mg, 12.1% V, and 54.6% 0. Additionally, FTIR analysis of the surface indicated the presence of decavanadate ions (V₁₀O₂₈⁶⁻) and polymeric anions [V₃O₈]ₙⁿ⁻ such as V₆O₁₆²⁻. Antisymmetric stretching of decavanadate anions were observed at 812 cm⁻¹, symmetric stretching of decavanadate ions or terminal VO₃ units were observed at 957 cm⁻¹, 1025 cm⁻¹. These FTIR peaks were not present in samples that were analyzed before treatment in the bath containing the vanadium salts. When viewed through an SEM, the surface was similar in structure to an unconverted interconnected magnesium oxide structured ceramic.

### Example 11

A low temperature (<100° C.) thermochromicially active surface modification was created by converting an interconnected magnesium oxide structured ceramic surface modification prepared on a substrate as described above. The magnesium oxide surface modification was white in color after the thermal annealing step. The surface modified substrate was immersed in an aqueous conversion bath to convert the original ceramic metal oxide into mixed metal oxide which contained a thermochromicially active metal oxide. The immersion bath contained a salt of the desired metal, such as vanadium chloride or sodium orthovanadate. The aqueous solution was maintained at pH 3-7 with the addition of 1M nitric acid and optionally contained a buffer, such as a citric acid system, phosphoric acid system, carbonate system, acetate system, or a common biological buffer such as tris or MOPS. After pH dosing, the solution turned a bright orange color signifying the presence of decavanadate ions. All components were at a concentration ranging from 0.01M to 1M, typically about 100 mM. The conversion occurred in an aqueous solution maintained between 20° C. and 90° C., typically 20° C., with immersion time from 60 to 1500 minutes, typically about 120 minutes. Following immersion, the sample was thoroughly rinsed with de-ionized water and the sample was baked at 400° C. for 60 minutes. After the substrate was removed from the immersion bath at 20° C. and 60° C., the color of the surface was a yellow-orange color signaling the presence of vanadium compounds on the surface. After the bake step, the sample still had some orange on the surface of the material demonstrating the presence of vanadium compounds on the surface. XRF analysis showed that the presence of vanadium in the samples. Additionally, SEM analysis showed that the surface structure of the vanadium converted magnesium oxide was similar to the unconverted magnesium oxide—both surfaces were interconnected.

### Example 12

A luminescent ceramic surface modification is created by converting a metal oxide structured ceramic surface modification prepared on a substrate as described above. The surface modified substrate is immersed in an aqueous conversion bath to introduce luminescence or to convert the metal oxide into a luminescent compound. The aqueous solution may contain a luminescent source such as europium nitrate or quinine. All components are at a concentration ranging from 0.01M to 1M. The conversion occurs in a heated aqueous solution between 50° C. and 90° C., with immersion time from 60 to 1500 minutes. Following immersion, thermal annealing occurs at temperatures from 100° C. to 600° C. for 60 to 1500 minutes.

### Example 13

A carbonate-based corrosion protection layer was created through by converting an interconnected metal oxide structured ceramic surface modification prepared on a substrate as described above. An aluminum alloy substrate that had been previously modified with an interconnected magnesium oxide structured surface modification was immersed and retained in a chamber containing a UV light source with light from 295-340 nm and an irradiance of 1-2 W/m2/nm, at 70° C. The chamber contained water in equilibrium with ambient CO₂. The samples were held in the chamber for 500 hr.

Samples were assessed in an acidic salt fog test according to ASTM G85 A3 for 94 hours alongside unconverted samples. The number of observed defects from corrosion pitting was reduced, in comparison to unconverted surface modified samples.

### Example 14

A magnesium oxide interconnected porous ceramic surface modification is applied to aluminum particles, powder, flakes, or extrudates with a maximum dimension less than 1 cm as described above. The coating thickness and particle size are selected such that the aluminum to magnesium ratio is greater than 2 to 1. These particles, powder, flakes, or extrudates are then post processed using sintering, casting, or molding into a monolith or netshape object by melting the aluminum substrate and flowing it through the porous ceramic coatings resulting in a ceramic-metal composite with increased strength relative to aluminum.

### Example 15

An interconnected magnesium oxide structured ceramic surface modification is applied to aluminum particles, powder, flakes, or extrudates with a maximum dimension less than 1 cm as described above. The coating thickness and particle size are selected such that the aluminum to magnesium ratio is about 2 to 1. These particles, powder, flakes, or extrudates are then post processed using sintering, casting, or molding into a monolith or netshape object by melting the aluminum substrate and flowing it through the porous ceramic coatings resulting in a spinel monolith due to the reaction of the molten aluminum with a stochiometric quantity of magnesium oxide. The process is repeated using a titania coating on aluminum particles to create aluminum titanate.

### Example 16

An interconnected magnesium oxide porous ceramic surface modification is applied to aluminum particles, powder, flakes, or extrudates with a maximum dimension less than 1 cm as described above. The magnesium oxide layer provides electrical insulating properties relative to uncoated aluminum. The modified power, flakes, particles or extrudates are then added to a resin or binder to create a thermally conductive paste with electrically insulating properties

### Example 17

An interconnected magnesium oxide porous ceramic surface modification was applied to a brazed aluminum heat exchanger. The heat exchanger was then placed in a bath to partially convert the surface modification to a carbonate-based corrosion protection layer. This was created by converting a structured metal oxide ceramic surface modification prepared on a heat exchanger as described above. The brazed aluminum heat exchanger that had been previously modified with a structured magnesium oxide surface modification was immersed in an aqueous carbonate conversion bath. The carbonate conversion occurred in a heated aqueous solution between 50° C. and 90° C. This solution requires one component comprising the carbonate source. This may be a carbonate salt, such as potassium carbonate, sodium bicarbonate, ammonium bicarbonate, or a source to create carbonic acid in solution such as bubbled carbon dioxide. The carbonate concentration is between 0.01M and 1M, typically about 100 mM and optimal immersion time from 600 to 1500 minutes. The heat exchanger was removed prior to complete conversion to carbonate resulting in a surface comprising both carbonate containing ceramics and metal hydroxides. The heat exchanger was then subjected to ASTM G85-A3 salt spray test and resulted in a surface that had, on average less salt build up and corrosion products at 1000 hours compared to the uncoated heat exchanger.

### Example 18

An interconnected zinc oxide porous ceramic surface modification was deposited onto a 3003 Al substrate as described above. The interconnected zinc oxide modified 3003 aluminum alloy substrate was then placed into a second deposit bath containing manganese nitrate salts and a complexing agent (such as hexamethylenetetramine) as described above at a temperature between about 50° C. and 80° C. for about 10 minutes to about 90 minutes. This resulted in a manganese oxide filled zinc oxide porous ceramic network. The presence of both zinc and manganese were demonstrated by analysis with EDS and showed that the surface of the interconnected material contained both zinc and manganese oxides.

### Example 19

An interconnected structured manganese oxide modified aluminum panel as described above is created. The modified panel is then filled with another ceramic material by sputtering, ALD, or casting solutions of metal salts or suspensions of metal particulate into the pores. This results in a ceramic filled interconnected ceramic network. The first and second ceramics can be the same or different ceramic materials.

### Example 20

A clean 4006 aluminum foil substrate was coated with an interconnected structured ceramic surface based on a mixture of magnesium, cerium and aluminum oxides. Krypton BET surface area measurements indicate that the surface area is about 200 square meters per square meter of projected substrate surface area.

### Example 21

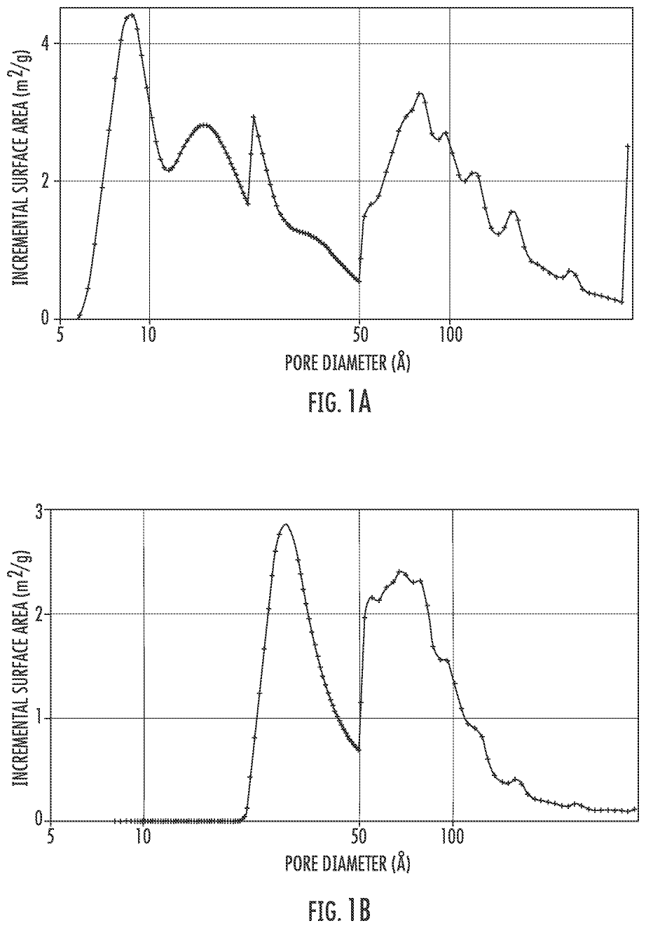

A clean 4006 aluminum foil substrate was coated with an interconnected structured ceramic surface based on a mixture of magnesium and aluminum oxides. The surface was then functionalized using a dilute solution of hexadecylphosphonic acid in isopropanol, similar to the procedure in Example 16. Nitrogen BET surface area measurements indicated that the surface area is 300 to 500 square meters per square meter of projected substrate surface area and that the mass specific surface area of the ceramic material is 150 to 200 m²/g. Mercury porosimetry indicated that there is a bimodal pore size distribution with pore sizes concentrated at about 5 nm and about 30 nm. BJH measurements indicate the volume of pores smaller than 2.7 nm in diameter is effectively zero. This indicates that the smallest pores are 2.7 nm in diameter. Pore size distributions as determined by BJH adsorption measurements before and after the partial filling surface functionalization are shown in FIGS. 1A-1B. Additionally, mercury porosimetry indicates the material is 52% to 69% porous relative to the bulk oxide material.

### Example 22—Ceramic-Ceramic Composite Material

A mixed metal interconnected ceramic surface modification was created by converting a structured magnesium oxide ceramic surface modification prepared on a 1 mm thick 3003 aluminum alloy substrate as described above. The substrate was then placed on a wire rack and subjected to thermal treatment conditions between 650° C. and 1800° C. At these conditions, the substrate melted but the ceramic surface modification did not. The melted substrate flowed through the pores of the ceramic surface modification into a drain pan underneath the wire rack. Upon cooling of the sample, two regimes were present, one regime contained only the surface modification and this regime was held together because the ceramic surface modification was interconnected. The other regime contained the surface modification and the solidified substrate which was held up due to surface tension. When the substrate reached its melting point, it filled the pores of the ceramic surface modification. Upon further heating, the substrate was oxidized to aluminum oxide resulting in an interconnected magnesium oxide and aluminum oxide structured ceramic material. This created an interconnected aluminum oxide—magnesium oxide composite material.

### Example 23

A mixed metal ceramic surface modification is created by converting an interconnected structured metal oxide ceramic surface modification prepared on a cellulosic substrate, such as cellulose acetate, as described above. The surface modified substrate is immersed in an aqueous conversion bath to introduce an anionic form of another metal. The surface modified substrate is immersed in an aqueous conversion bath to convert the original ceramic metal oxide into mixed metal oxide which contained a thermochromicially active metal oxide. The immersion bath contains a salt of the desired metal, such as vanadium chloride or sodium orthovanadate. The aqueous solution is maintained at pH 3-7 with the addition of 1M nitric acid and may contain a buffer, such as a citric acid system, phosphoric acid system, carbonate system, acetate system, or a common biological buffer such as tris or MOPS. All components are at a concentration ranging from 0.01M to 1M, typically about 100 mM. The conversion occurs in an aqueous solution maintained between 20° C. and 90° C., typically about 70 C, with immersion time from 60 to 1500 minutes, typically about 90 minutes. Following the immersion step, the solution is thoroughly rinsed with de-ionized water and allowed to dry.

Although the foregoing invention has been described in some detail by way of illustration and examples for purposes of clarity of understanding, it will be apparent to those skilled in the art that certain changes and modifications may be practiced without departing from the spirit and scope of the invention. Therefore, the description should not be construed as limiting the scope of the invention.

All publications, patents, and patent applications cited herein are hereby incorporated by reference in their entireties for all purposes and to the same extent as if each individual publication, patent, or patent application were specifically and individually indicated to be so incorporated by reference.

1. A composition comprising a binderless porous ceramic material that comprises an interconnected network of ceramic in contact with a substrate, wherein the substrate is a metal or a metal alloy, and wherein the binderless porous ceramic material comprises pores that are partially or completely filled with a second ceramic material.

2. (canceled)

3. The composition according to claim 1, wherein the substrate and the binderless porous ceramic material each comprise a primary metal, and wherein the primary metal in the binderless porous ceramic material is different than the primary metal in the substrate.

4. The composition according to claim 1, wherein the interconnected network of ceramic on the substrate comprises a thickness of about 1 micrometer to about 100 micrometers.

5.-6. (canceled)

7. The composition according to claim 1, wherein the composition comprises a plurality of interconnected networks of ceramic in contact with the substrate.

8. (canceled)

9. The composition according to claim 1, wherein the binderless porous ceramic material comprises a rare earth element, a transition metal element, an alkaline earth metal element, or aluminum.

10. The composition according to claim 1, wherein the binderless porous ceramic material comprises an oxide, a hydroxide, or a layered double hydroxide.

11. (canceled)

12. The composition according to claim 1, wherein the binderless porous ceramic material comprises a phosphate, a carbonate, a titanate, an aluminate, a zirconate, a fluoroaluminate, a silicate, a sulfide, a vanadate, a tungstate, a stannate, or a sulfate.

13. The composition according to claim 1, wherein the substrate comprises an aluminum alloy, a magnesium alloy, a steel alloy, a nickel alloy, a titanium alloy, aluminum, magnesium, nickel, zinc, a zinc alloy, calcium, a calcium alloy, a ferrous alloy, copper, a copper alloy, titanium, a titanium alloy, or a cobalt-chromium containing alloy.

14.-17. (canceled)

18. The composition according to claim 1, wherein the binderless porous ceramic material comprises a surface area of about 10 m² to about 1500 m² per square meter of projected substrate area.

19. (canceled)

20. The composition according to claim 1, wherein the binderless porous ceramic material comprises a mean pore diameter of about 2 nm to about 20 nm.

21. The composition according to claim 1, wherein the binderless porous ceramic material comprises pores with a pore size distribution that is multimodal.

22. The composition according to claim 1, wherein the binderless porous ceramic material comprises a thickness up to about 50 micrometers.

23. (canceled)

24. The composition according to claim 22, wherein the binderless porous ceramic material comprises a porosity greater than about 10%.

25. (canceled)

26. The composition according to claim 1, wherein the binderless porous ceramic material comprises a void volume of about 100 mm³/g to about 7500 mm³/g as determined by mercury intrusion porosimetry.

27.-28. (canceled)

29. The composition according to claim 1, wherein the second ceramic material is different in composition than the ceramic in the interconnected network of ceramic.

30. The composition according to claim 29, wherein the interconnected network of ceramic comprises a hydroxide, an oxide, or a layered double hydroxide and the second ceramic material comprises a phosphate, a carbonate, a silicate, a sulfate, a titanate, a tungstate, a zirconate, a vanadate, a stannate, a zincate, or an aluminate.

31. The composition according to claim 1, wherein the interconnected network of ceramic and second ceramic material each comprise a primary metal, and wherein the primary metal of the interconnected network of ceramic and the primary metal of the second ceramic material are the same.

32. The composition according to claim 1, comprising an interface between the interconnected network of ceramic and the second ceramic material, wherein the interface comprises a gradient.

33. (canceled)

34. A metal-ceramic composite comprising an assembly of substrates, wherein each of said substrates in said assembly of substrates is modified with a binderless porous ceramic material that comprises an interconnected network of ceramic in contact with the substrate, wherein each of said substrates in said assembly of substrates is a metal or a metal alloy, and wherein the binderless porous ceramic material comprises pores that are partially or completely filled with a second ceramic material.

35. (canceled)

36. A method of manufacturing a surface modified substrate, said method comprising:
depositing a porous ceramic material that comprises an interconnected network of ceramic on a metal or metal alloy substrate that is in the form of a particulate, a powder, an extrudate, or flakes, thereby producing a surface modified metal or metal alloy substrate, and
molding, casting, or sintering the surface modified metal or metal alloy substrate into a monolithic or net shape metal-ceramic or metal alloy-ceramic composite component,
wherein the metal or metal alloy substrate core comprises a lower melting point than the interconnected network of ceramic and the porous ceramic material is sufficiently porous to wick in and/or react with the molten metal or metal alloy.

37.-39. (canceled)
